(19) United States
(12) Patent Application Publication
(10) Pub. No.: US 2023/0050629 A1
(43) Pub. Date: Feb. 16, 2023

(54) CONTAINMENT DEVICE WITH REINFORCEMENT FRAME FOR INCREASED STRENGTH

(71) Applicant: Juan Antonio Herrero Perez Rioja, Puebla (MX)

(72) Inventor: Juan Antonio Herrero Perez Rioja, Puebla (MX)

(21) Appl. No.: 17/402,854

(22) Filed: Aug. 16, 2021

(51) Int. Cl. B65D 5/44; B65D 5/28

(52) U.S. Cl. CPC B65D 5/445; B65D 5/28

(57) ABSTRACT

A reinforced containment device, which is mainly composed of a main container (10) and a reinforcing frame (20) where it is arranged in the upper part of the main container (10) to increase its resistance. The reinforcing frame (20) is preferably composed of a sheet of paper, cardboard or similar materials generating a perimeter frame that has a sealing surface (25) in its upper part, wherein this frame is continuous, seamless and has a plurality of upper gluing tabs (21) that extend from a fold (22) that meets the upper part of the walls (12) of the main container (10).

### TECHNICAL FIELD

The present invention belongs to the technical field of containment devices, specifically to devices made of paper, cardboard or material worked in a similar way to paper, more specifically to the field of containers of types of paper or cardboard, even more specifically to containers with some type of special arrangement that gives them better properties in their structure and even more specifically, the present invention refers to a reinforced containment device.

### BACKGROUND

At present, in the field of commercial trays or containers it is known that more ecological packaging solutions are sought in all senses, in the food area a proposal is paper and cardboard trays that in addition to meeting the characteristics of being recyclable, biodegradable, among others, they are very practical because they can be used as a support plate or to transport products, and their manufacturing process, unlike products such as molded paper, is that it allows us to change shapes and sizes according to the customers' needs changing only small low-cost tools in addition to the fact that its surface can be printed, which allows, in addition to a very good image, to be able to include all kinds of information on the same tray without the need for additional labeling.

In the state of the art, a significant variety of devices are known that attend the presentation of inventions similar to those of the present invention, in the US patent application US20080245849A1 reference is made to a generally parallelepiped corrugated box for packaging and transporting objects, where the box comprises a lid formed by a side cardboard with a tin strip that includes a front wall, a rear wall and side walls, another similar document is found in the application US20160236810A1 where there is a tray made of sheet material made of cardboard, where it comprises a rectangular bottom and a ring of side walls, that is, two opposite first side walls, called first walls, connecting at least one of the first walls on each side by the first folding lines.

Another document that generally reveals the state of the art of the present invention is European patent EP1719708B1, where mention is made of a semi-rigid material tray, lined with an inner thermoplastic film of thermoplastic material, in which a basket made of a semi-rigid material, such as cardboard, corrugated cardboard or the like, comprising at least two separate adjacent compartments, each of which is covered internally and along its upper edge with a film of deformable material, in particular of thermoformed thermoplastic material, each compartment comprises a lower part arranged in the extension of that of the adjacent compartment, while its adjacent side walls are arranged in the extension of the other, or are contiguous and then provided with a manual separation means, the compartments are arranged or not arranged symmetrically in relation to the median plane of the perpendicular basket to its bottoms, said basket being characterized in that each compartment comprises in the vicinity of the adjacent compartment, a wall that is perpendicular to the bottom is not provided with a support of semi-rigid material and is formed solely from said firm material deformation film, and that this film joins the two adjacent walls of the two compartments, in the upper part of the same, and forms a flat strip parallel to their bottoms and located at such a distance from which a closing lid of the basket can support this 30 strip and fastened thereto, and in that a cut is provided in the lower part of semi-rigid material parallel to the adjacent walls, below said flat strip, in which, along the lateral edges of the cut, the fins are articulated by folding lines and can move with respect to the lower part and whose width is equal to half that of the cut, and in which the notches are provided in the upper part interior of adjacent side walls perpendicular to the ends of the cut.

In the US patent application U.S. Pat. No. 4,351,473A a tray container with a removable lid is described, where it is formed of cardboard that has a coating of heat-sealable and heat-resistant film material and that, when fully configured, has a bottom wall rectangular with vertical side walls that are connected at the corners by a bent triangular band members and that have an outwardly directed flange formation at the upper edges where the margins of a cover member of the same material can be adhesively secured with the possibility of tearing off the main portion of the lid member to reveal the contents in the tray while leaving substantial marginal portions of the lid member intact and secured in reinforcing relationship on the flange of the tray.

In US application U.S. Pat. No. 4,042,167A a new extended edge tray is provided assembled from a single paper blank; the blank includes a main and a minor panel integrally connected along a folding spine forming a flange. The main panel is dimensionally larger than the smaller panel. Other discreetly collapsible rim-forming members are formed along the edges of the smaller panel. To assemble the tray, the flange is formed on the spine and the sub panel is rotated 180° until it overlaps the main panel. The minor panel is secured to the main panel and the tabs are formed on it. The means provided for interlocking flanges and adjacent corners defined between them are integrally formed with the entire tray. None of the cut edges of the blank are exposed in the assembled tray. A suitable cover can be telescoped over the upright flanges to cover the open tray.

A reinforced cardboard container is mentioned in the application U.S. Pat. No. 5,772,108A where it is formed from corrugated cardboard with overlapping flaps to eliminate spaces in the bottom wall of the container, having also has pre-stretched polypropylene straps that are automatically applied to the container when it is in its flattened condition to provide periphery support to the container when in its erected condition. The straps are placed from the lower portion of the container side walls at increasing distances from each other to limit the bulging of the container when transporting products that have varying effects on the container. With such an arrangement of belts, economically and environmentally desirable single and double-walled corrugated cardboard can be used where triple-walled and laminated cardboard containers are typically used.

The disadvantages found in the prior art mainly occur when a problem occurs with the paper or cardboard trays that currently exist on the market, since they make packaging, transport, and display difficult due to the following points:

1) If you do not have a perimeter frame, you do not have functional solutions to put a top or sealed cover, or pressure.

2) The options on the market with a perimeter frame are based on leaving a surplus of the material of the container walls that must be bent normally towards the outside looking for them to be perpendicular to the upper perimeter of the tray, however, it has three problems.

The memory of the material with which they are made makes it normally return in different proportions which hardly allows the frame to be perpendicular.

It does not have enough strength to be supported only by the perimeter frame, which is necessary for many packaging processes, because the surface of the frame is formed by the independent sum of the sections of the frame that protrude from each of the walls. container and not mutually supportive.

Due to the little force that these solutions present, the caps sealed on their surface cannot be kept taut enough, which in turn does not allow to stow or place a tray with product and already covered on another without being mistreated or compressed. the product from the bottom tray, affecting costs and efficiencies in secondary packaging, freight, and exhibition spaces.

The foregoing results in notorious disadvantages for the user since it prevents them from having these elements, reducing the comfort in the use of trays, their reliability and, above all, the integrity of the load they store. For these reasons, there is a need for a device that offers the possibility of solving the aforementioned problems.

This object is achieved by means of the device developed with the present invention and its preferred embodiments.

Another object of the invention consists of a reinforced containment device (1) with much higher rigidity than the existing alternatives that allows greater support when sealing; keep the frame surfaces practically perpendicular to the upper contour of the container.

Still another object of the invention is to provide a modified reinforced containment device for loading the trays by holding them only by the frame for sealing, capping and transport processes without the rest of the container having contact with any surface.

Another object of the invention is a reinforced containment device having a frame with a sealing surface that can extend towards the inside and/or outside parallel to the upper perimeter of the container.

Another object of the invention consists of a reinforced containment device that allows one tray to be stowed or placed on another without compressing the product from the one below, either by resting it on the sealed lid or simply on the container frame below when it is inside.

Another object of the invention consists of a reinforced containment device whose essential characteristics allow the manufacture of different shapes in the inner and outer profiles of the frames as they are an extension of the container walls.

Another object of the invention consists of a reinforced containment device whose essential characteristics make it possible to reduce the caliber of the containers without losing strength.

Another object of the invention consists of a reinforced containment device that has a microwaveable film so that the container can be entered in a microwave device without affecting its structure or composition.

The objectives of the present invention referred to above and still others not mentioned, will be evident from the description of the invention and the figures that accompany it with an illustrative and non-limiting nature, which are presented below.

### OBJECT OF THE INVENTION

Therefore, the present invention has the task of presenting a device that solves the previously described drawbacks and provides significant advantages in its utility, since it is a reinforced containment device, with similar characteristics to those described in the aforementioned documents, with a series of components in its structure that allow a simple, resistant and reliable assembly for the user and for the load that is deposited inside, in the same sense it should be understood that the problem underlying the invention is to provide a containment device that allows to deposit loads for transfer and/or storage without damaging it, taking into account that the container must also bear loads and efforts caused by movements during transport, stowed and storage.

### BRIEF DESCRIPTION OF THE FIGURES

FIG. 1 shows a top view of the main container (10) extended;

FIG. 2 shows a front view of the main container (10);

FIG. 3 shows an isometric view of the main container (10);

FIG. 4 shows a top view of the reinforcing frame (20);

FIG. 5 shows an isometric view of the reinforcing frame (20);

FIG. 6 shows an isometric view of the reinforced containment device;

FIG. 7 shows a top view of one embodiment of the reinforcing frame (20);

FIG. 8 shows a top view of one embodiment of the reinforcing frame (20);

FIG. 9 shows an isometric view of one embodiment of the reinforcing frame (20);

FIG. 10 shows an isometric view of the reinforced containment device;

FIG. 10a shows a side view of the reinforced containment device;

FIG. 11 shows a top view of one embodiment of the reinforcing frame (20);

FIG. 12 shows a sectional isometric view of the reinforced containment device.

FIG. 13 shows a top view of the reinforcing frame (20);

FIG. 14 shows an isometric view of one embodiment of the reinforcing frame (20);

FIG. 15 shows a sectional isometric view of the reinforced containment device;

FIG. 16 shows a sectional isometric view of the reinforced containment device;

FIG. 17 shows a top view of one embodiment of the reinforcing frame (20);

FIG. 18 shows an isometric view of one embodiment of the reinforcing frame (20);

FIG. 19 show a first view of the reinforced containment device;

FIG. 19a show a second view of the reinforced containment device;

FIG. 19b show a third view of the reinforced containment device;

FIG. 20 shows a top view of one embodiment of the reinforcing frame (20);

FIG. 21 shows an exploded view of the reinforced containment device;

FIG. 22 shows an isometric view of the reinforced containment device;

FIG. 23 shows an isometric view of the reinforced containment device;

FIG. 24a shows a side of the reinforced containment device;

FIG. 24b shows an exploded view of the reinforced containment device;

FIG. 24c shows a view of the reinforced containment device;

FIG. 25a shows an exploded side view of the reinforced containment device;

FIG. 25b shows an exploded side view of the reinforced containment device of FIG. 25a;

FIG. 25c shows side view of the reinforced containment device of FIG. 25a;

FIG. 26a shows an exploded side view of the reinforced containment device;

FIG. 26b shows an exploded side view of the reinforced containment device of FIG. 26a;

FIG. 26c shows side view of the reinforced containment device of FIG. 26a;

FIG. 26d shows side view of the reinforced containment device of FIG. 26a;

FIG. 27a shows an exploded side view of the reinforced containment device;

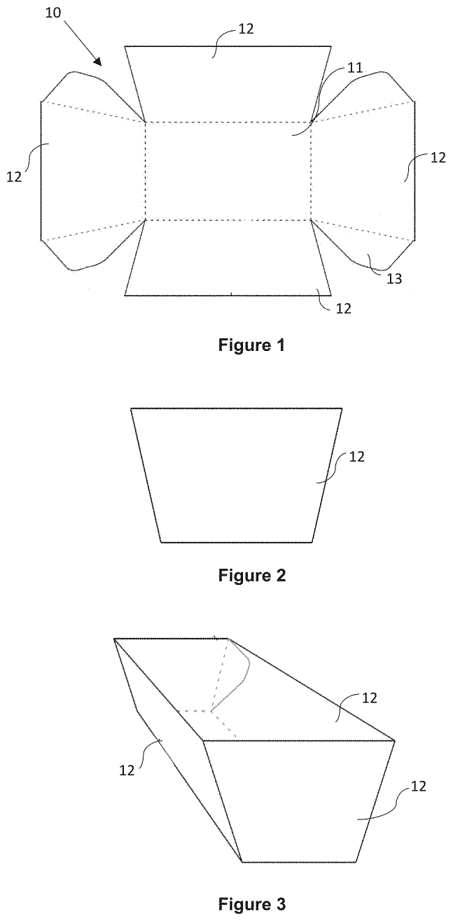

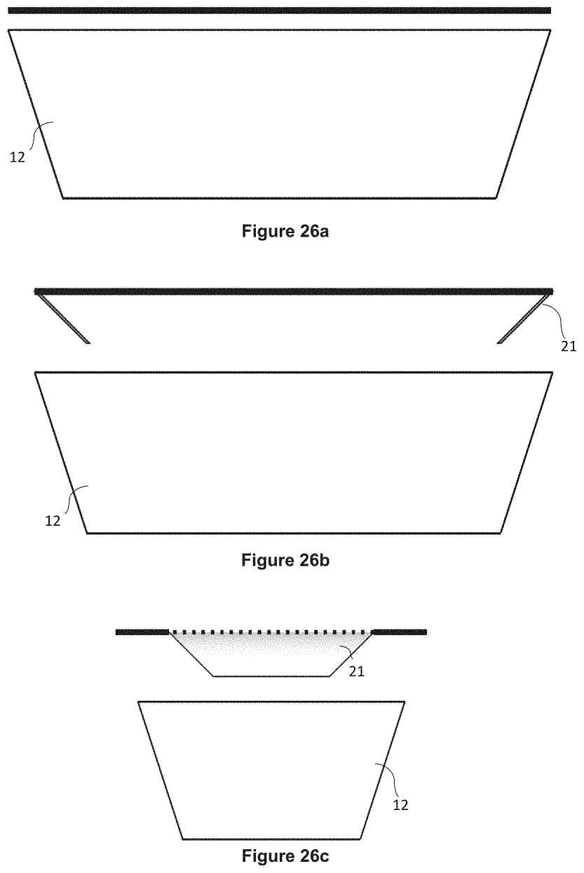

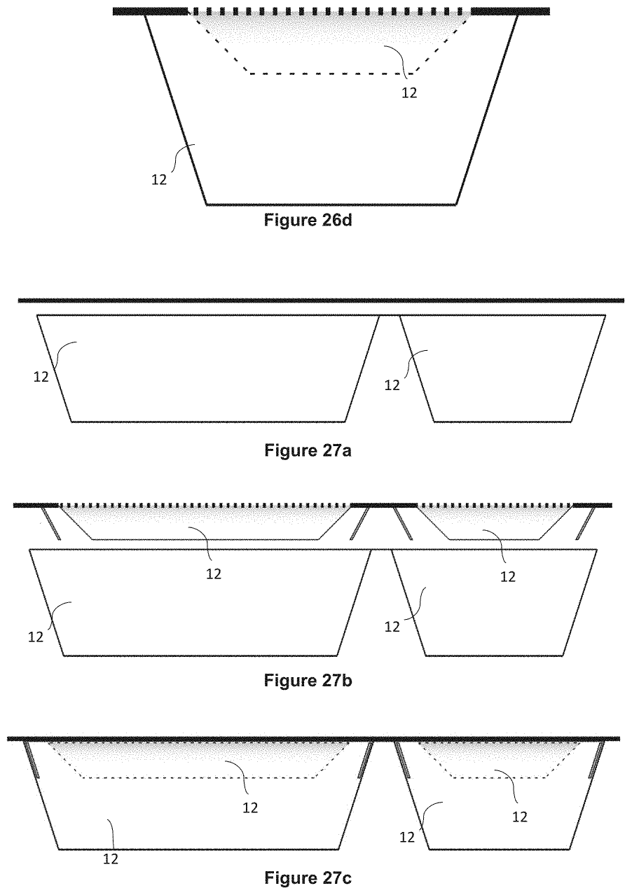

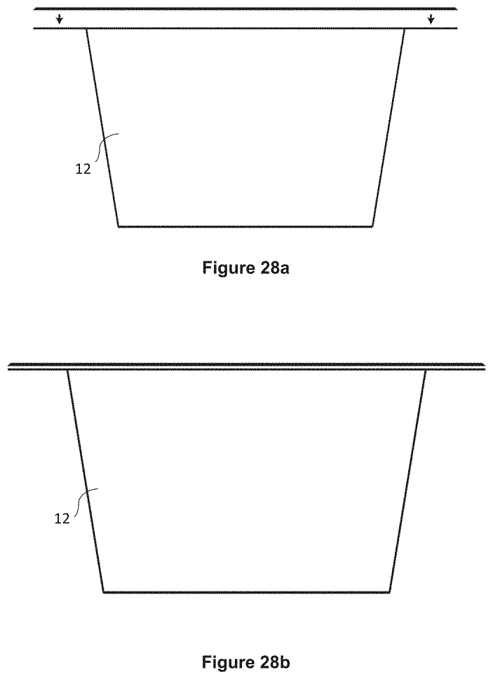

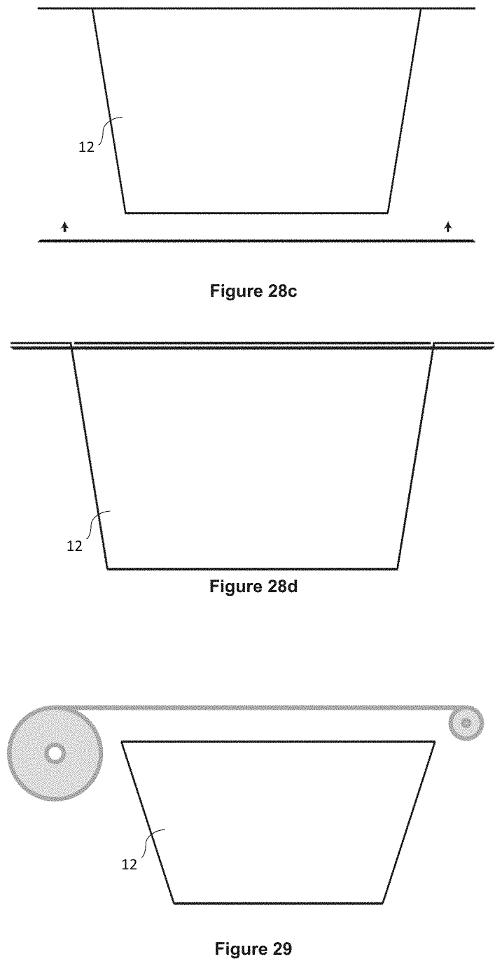

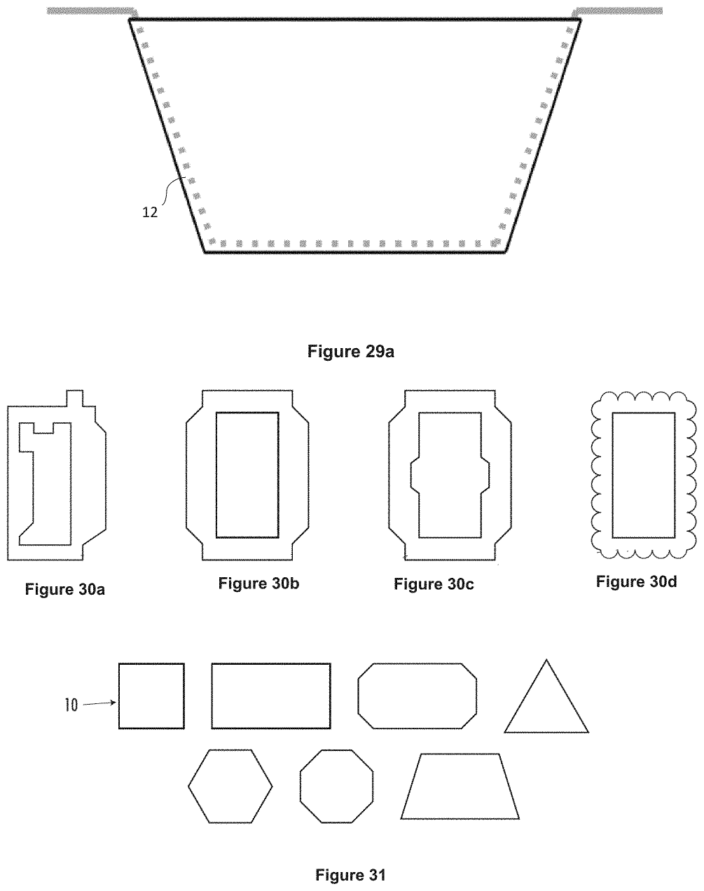

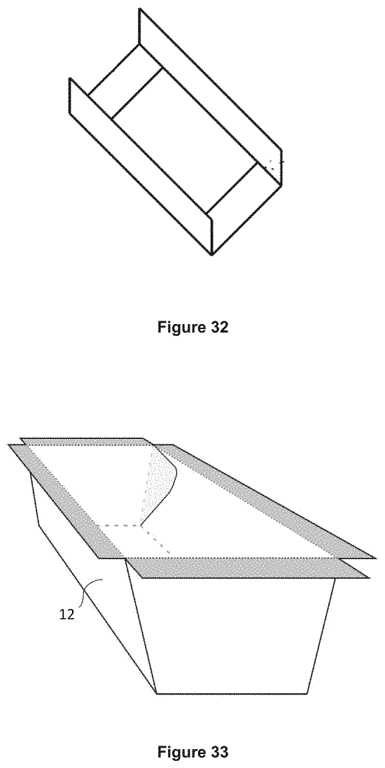

FIG. 26b shows an exploded side view of the reinforced containment device of FIG. 27a;

FIG. 27c shows side view of the reinforced containment device of FIG. 27a;

FIG. 28a shows an exploded side view of the reinforced containment device;

FIG. 28b shows an exploded side view of the reinforced containment device of FIG. 28a;

FIG. 28c shows side view of the reinforced containment device of FIG. 28a;

FIG. 28d shows side view of the reinforced containment device of FIG. 28a;

FIG. 29 shows a side view of the reinforced containment device;

FIG. 29a show a side view of the reinforced containment device;

FIG. 30a shows top view of a container (10);

FIG. 30b shows top views of a container (10);

FIG. 30c shows top views of a container (10);

FIG. 30d shows top views of main container (10);

FIG. 31 shows a top view of a plurality of upper profiles of the main container (10);

FIG. 32 shows reinforcements of the sealing surface ends (25) when the adjoining perpendicular sealing surface is bent; and

FIG. 33 shows an isometric view of a prefabricated main container (10).

### DESCRIPTION OF THE INVENTION

In order to provide an understanding of the principles of the invention, reference will now be made to a preferred embodiment illustrated in the figures, and specific language will be used to describe the same. However, it will be understood that it is not intended to limit the scope of the invention, such additional alterations and modifications to the apparatus illustrated in the accompanying images and such additional applications of the principles of the invention as illustrated therein are contemplated as would normally occur now or in the future for a person skilled in the art to which the invention relates.

The solution offered by this invention is to place frames that are formed in a single plane, are continuous, preferably without joints and are independent of the containers, in addition to the fact that these can be towards the inside of the container, towards the outside of the container or a combination of both as explained in the description of each type of frame.

The present invention refers to a reinforced containment device, where it generally consists of a tray, made of paper, cardboard, thin cardboard, coated cardboard, corrugated cardboard, or similar materials made of cellulose, although the incorporation of other polymeric and even metallic materials that is made up of two main components, firstly a main container (10) and a reinforcing frame (20), the latter being arranged on top of the former and increasing the resistance of the device in general, making this support a greater amount of load in its upper part, as well as having benefits during the stowage of several trays; In the same sense, the reinforcement frame has a sealing surface (25) in its upper part arranged to fulfill two main functions.

In a first aspect, it is the generation of a flat and continuous frame aligned to the upper contour of the main container (10) to be able to close with different types of lids, preferably thermo-sealable, with adhesives, pressure, etc. and where this closure is flat, which promotes a better closure and increases the hermeticity inside the container.

In a second aspect, there is sufficient rigidity to support the tray by holding it only on the sealing surface (25) of the reinforcing frame (20), which is achieved since this sealing surface (25) is preferably made of a single piece, although it is also considered the union of several pieces that are coupled and sealed synchronously for a complete adjustment of each of its profiles, thus obtaining the necessary firmness even when the main container (10) is already full of content, which makes it functional in some processes in a production line such as filling, closing, sealing or transport, among others.

It is therefore a main object of protection, a reinforced containment device (1) comprised of a first component, this being a main container (10) made up of a tray, generally made of paper, cardboard or the like, said main container (10) which is comprised of a base or bottom (11) and four walls (12) raised from the perimeter of the base, having a straight arrangement or with some inclination and are joined together by means of a series of lateral flanges (13) arranged on each of the sides of two of the walls (12) opposite each other, said side flanges (13) joined to their corresponding wall (12) by means of bending plates, said walls forming an edge in the upper part substantially rectangular continuous perimeter; The containment device (1) also includes: a second component, this being a reinforcing frame (20) made of materials similar to those of the tray or tray, where the reinforcing frame (20) is arranged on the upper continuous perimeter edge of the main container (10) and is mainly comprised of: a sealing surface (25) made up of a perimeter frame made in a single piece and in a single, uniform and continuous plane aligned to the upper contour of the main container (10); and by a plurality of upper gluing tabs (21) that extend from the edge of the sealing surface (25) through a fold (22) that give rise to said upper gluing tabs (21), in where these gluing tabs (21) meet overlapping with the upper part of the walls (12) of the main container (10).

The main container (10), of the reinforced containment device (1), object of the present invention, is arranged in the form of a simple tray manufactured by techniques well known in the industry, which through processes such as stamping or stamping, formed and glued, a container is obtained that has a bottom (11), on the perimeter of this four walls (12) are erected that are joined together by means of a series of lateral flanges (13) arranged in each of the sides of at least two of the walls (12) opposite each other, preferably using the same material from which the walls are manufactured, having these walls (12) can have a straight arrangement or with some inclination, in a preferential embodiment of the main container (10) of the invention, previously manufactured trays can also be used, while in another embodiment of the invention, the main container (10) can be created from an extended tray and shape it during the same process of gluing the reinforcing frame (20).

In a preferential embodiment of the present invention, the main container (10) has a plurality of perforations (not illustrated) in each of its walls (12) that are preferably made by known punching or die-cutting processes, which advantageously these are used as means of ventilation, humidity control, design, among others, these perforations in the walls do not imply major alterations in the structure of this.

The reinforcing frame (20) of the reinforced containment device (1), object of the present invention, is preferably composed of a sheet of paper, cardboard or similar materials that generates a reinforcing frame (20) that has a sealing surface (25) in its upper part, having that this frame is preferably made of a single piece, although it is also considered the union of several pieces that are coupled and sealed synchronously for a complete adjustment of each of its profiles and includes a plurality of upper gluing tabs (21) that extend from the edge of the sealing surface (25) through the fold (22) that give rise to said tabs, where they are joined overlapping with the upper part of the walls (12) of the main container (10), in a parallel or inclined arrangement with respect to the upper part or periphery of the container.

For the purposes of the present invention, there is a series of embodiments of the arrangement of the reinforcing frame (20), in particular for the present invention there are at least five different types of reinforcing frames (20), in which they have the following characteristics as constants:

The reinforcing frame (20) is made of a single continuous, flat piece without joints; however, a single reinforcing frame (20) can also be obtained by joining two or more of these components together, forming a perimeter that It has a sealing surface (25), and it is completely joined in each of its corners, in this embodiment the processes in the manufacture of the frame are increased but there is the advantage of less material consumption.

The most relevant differences between the types of reinforcing frames (20) available in each of the embodiments of this are mainly in the arrangement of the gluing tabs (21) with respect to the sealing surface (25) and therefore when the gluing tabs (21) are adhered to the walls of the main container (10), the position of the reinforcing frame (20) with respect to the position of the main container (10) can be of the following type:

### 1. Inside

### 2. Exterior

### 3. Mixed

### 4. Multi-cavity

### 5. Reinforcement

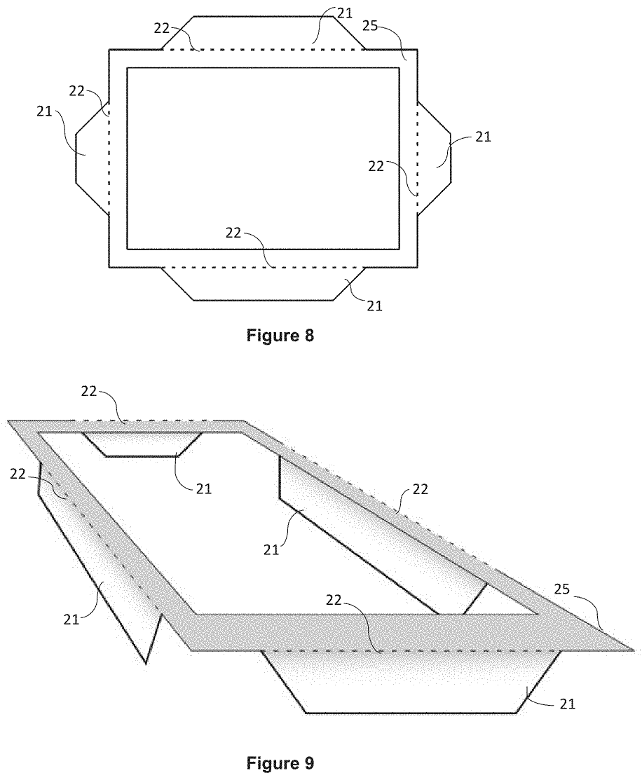

In a first embodiment of the reinforcing frame (20), it is arranged inside the main container (10), where, as can be seen in FIGS. 8, 9, 10, 10a and 12, the main container (10) and the reinforcing frame (20) consists of a portion of cardboard or paper, preferably, in this first embodiment the sealing surface (25) of the reinforcing frame (20) defines an outer perimeter edge from which the flanges of glued (21) and an inner perimeter edge, so that the outer perimeter edge of the sealing surface (25) has a geometric shape that is dimensionally coincident with the upper perimeter edge of the main container (10), so that the tabs of gluing (21) overlap and join with the inside of the walls (12) of the main container (10), and the outer perimeter edge of the sealing surface (25) maintains a dimensional equivalence with respect to the size of the mouth of the main container (10) with except for the dimension that is required for the sealing surface (25) to be inserted into the main container (10) in a perpendicular manner, the sealing surface (25) defining an inner flange of the container (10), the upper contour of the container (10), it can be straight, parallel to the beginning of the upper gluing tabs (21) or with different shapes, be it curves, cuts, among others.

When making the previous process of stamping or punching to mark the bending plates (22) in the reinforcing frame (20) and cutting the material, a surface is obtained clearly marking two areas by means of the folds (22), the first is the sealing surface (25) and the second corresponding to the gluing tabs (21). The folds (22) coincide with the upper contour of the main container (10) on the inside of this, without necessarily reaching from end to end, where preferentially there is a sufficient tolerance that allows the absorption of small variations that exist in the manufacturing processes of the container, the gluing tabs (21) can be of different lengths depending on the space available for gluing or the force required in gluing and the height should preferably be at most the height from the wall (12) of the main container (10) and at least a height five times less than the height of the container.

The upper gluing tabs (21) are bent in a downward orientation in such a way that they are arranged inside the main container, parallel and practically close to the walls (12) as shown in FIG. 12, where they are adhered by means of conventional adhesives.

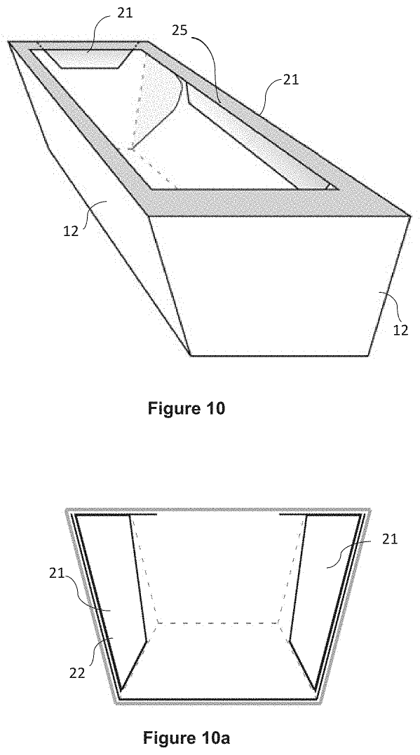

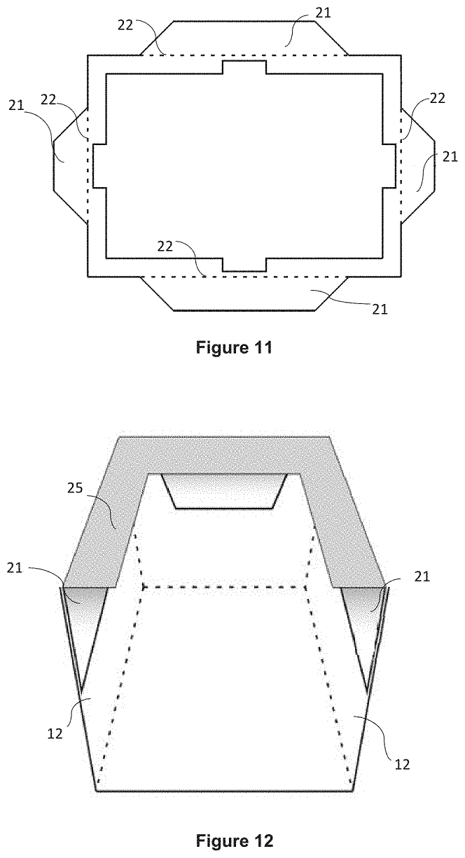

In one embodiment of this arrangement, the upper gluing tabs (21) have a height equal to the height of the wall (12) of the container (10) which generates the advantage of being of great help so that reinforcing frame (20) is positioned more easily and with greater precision in a parallel manner with respect to the bottom (11) of the main container (10), having the tabs are arranged perpendicular with respect to the upper contour of the main container (10) as shown in FIG. 10a, in addition to the fact that in this specific case, and as an assembly option, the tabs (21) could not adhere to the wall (12) and only support them on the bottom (11) of the main container (10) where the joint occurs by means of an outer wrap (not illustrated) that holds the two pieces together.

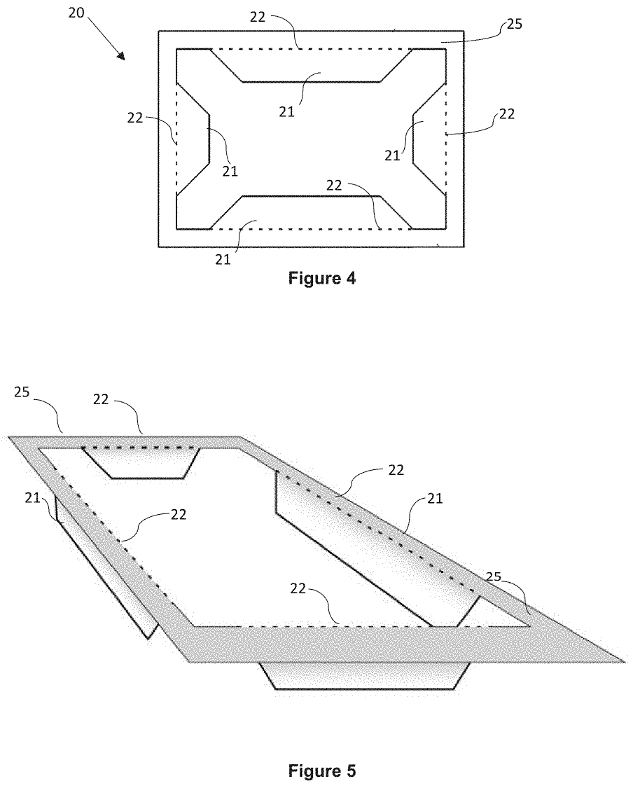

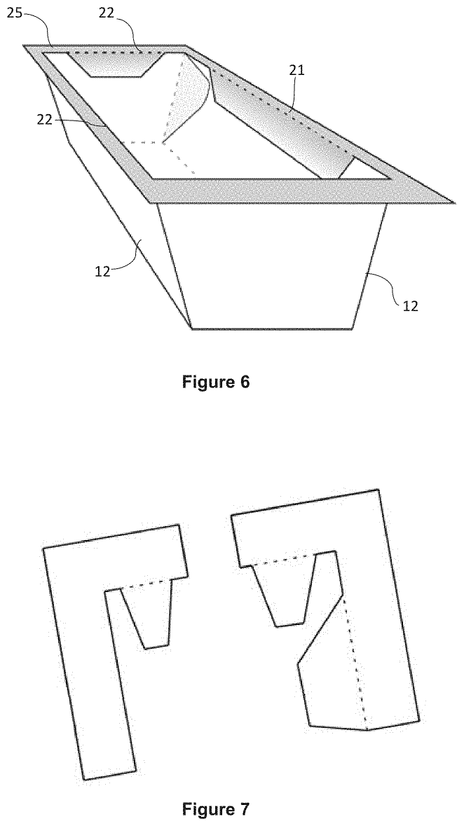

In a second embodiment of the reinforcing frame (20), this is arranged outside the upper periphery of the main container (10), as can be seen in FIGS. 4,5 and 6, this main container (10) and the reinforcing frame (20) preferably consists of a portion of cardboard or paper, with normally regular geometric shapes. In this second embodiment, the sealing surface (25) of the reinforcing frame (20) defines an outer perimeter edge and an inner perimeter edge from where the gluing tabs (21) project, so that the inner perimeter edge of the sealing surface (25) has a geometric shape that is dimensionally coincident with the upper perimeter edge of the main container (10), so that the gluing tabs (21) overlap and join with the inside of the walls (12) of the main container (10), and the inside perimeter edge of the sealing surface (25) maintains a dimensional equivalence about of the size of the mouth of the container (10), the sealing surface (25) defining an outer flange of the container (10), the width of the sealing surface (25) depends on what is required to protrude from the perimeter edge upper part of the main container (10), preferably this is five orders lower than the height of the container walls (12), in this way the sealing surface (25) is formed, the upper contour of the main container (10), it can be straight, parallel to the beginning of the upper gluing tabs (21) or with different shapes, be it curves, cuts, among others.

When making the previous process of stamping or punching to mark the folds (22) and cutting the material, a surface is obtained clearly marking two areas by means of the folds (22), the first having to refer to a sealing surface (25) and the second to the gluing tabs (21). The folds (22) are coincident with the upper internal contour of the container (10) with a sufficient tolerance that allows absorbing small variations that exist in the container manufacturing processes and can be of different dimensions both in length and width limited to the material available inside the frame and according to the required gluing area depending on the space available for gluing or the force required in gluing, where these gluing tabs (21) are bent in a downward direction inside the container, with respect to of its upper part so that they are practically together and parallel to the walls of the main container (10) to be adhered, preferably by conventional adhesives.

It is important to mention that advantageously, the reinforcing frame (20) by completely covering the periphery and being a continuous piece, at the time of loading through the gluing tabs (21) its strength maintains stability, since if any of its sides give a little due to the weight, the ends of that same side work to make a kind of stop to the gluing tabs (21) located perpendicularly at both ends as shown in the FIG. 32.

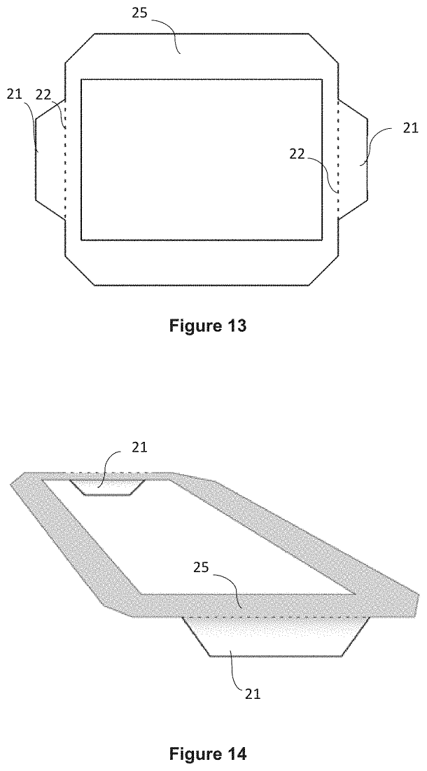

In a third embodiment of the reinforcing frame (20) this is arranged in a mixed way (both inside and outside), that is to say partially or totally located on one of the edges of the upper periphery of the main container (10), As can be seen in FIGS. 13 and 14, this reinforcing frame (20) consists of a portion of cardboard or paper, preferably with regular geometric shapes. Bearing in this embodiment that the reinforcing frame (20) is where the folds (22) of the gluing tabs (21) are located and that they are coincident with the upper contour of the container (10) on the inside, while that the sealing surface (25) is perpendicular to the upper contour of the main container (10), and it has two main characteristics:

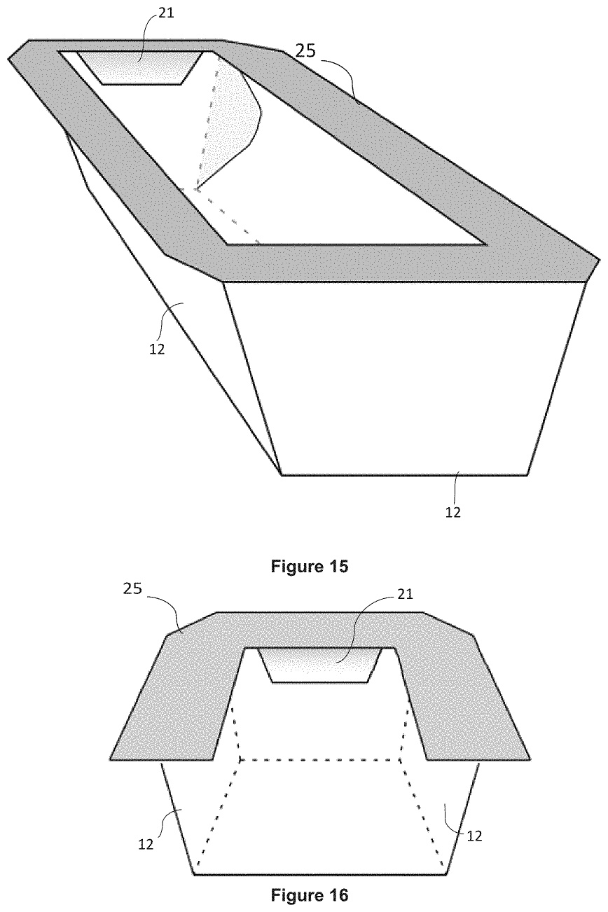

The first is that the sealing surface (25) has some sections placed on the inside of the container (10) or on the outside or both as shown in FIGS. 15 and 16, this allows the sealing surface (25) is broader in some areas and.

The second characteristic is that in the sections where there are sealing surfaces (25) arranged both externally and internally with respect to the main container (10), there is no gluing tab (21), nor is there a fold (22), which, in addition to having an initial support, adds the support of the upper contour of the main container (10) that is below the reinforcing frame (20) supporting the sealing surface in a parallel position, giving it greater resistance so that the container (FIG. 15) is loaded by the lower part of the sealing surface (25) and supports the handling of transport and packaging even with its contents.

In this third embodiment, the sealing surface (25), of the reinforcing frame (20), defines an outer perimeter edge and an inner perimeter edge, and has a polygonal shape like the upper edge of the main container (10), defining a plurality of sides, where alternately one of the sides of the sealing surface have glue tabs and other sides are free of glue tabs, where the outer perimeter or inner perimeter of the sides with the gluing tabs (21), the gluing tabs (21) are projected, said gluing tabs (21) being attached to the sealing surface by means of folds (22), so that the outer perimeter edge of the flanged sides of glued (21) presents a geometric shape that is dimensionally coincident with the corresponding sides of the upper perimeter edge of the main container (10), and the gluing tabs (21) overlap and join with the inside of the walls (12) of the main container (10), and the sealing surface (25) has straight sides free of gluing tabs (21), alternated with the sides with gluing tabs (21), where the straight sides, free of tabs of the sealing surface (25), they remain on the corresponding upper edges of the corresponding sides of the main container (10), where the upper edge of the main container (10) can coincide with the inner perimeter of the straight, free sides of flanges, of the sealing surface (25) defining an outer flange, or the upper edge of the container (10) may coincide with the outer perimeter of the straight, flange-free sides of the sealing surface (25) defining an inner flange, or the upper edge of the container (10) may be disposed between the inner and outer perimeter of the straight, flange-free sides of the sealing surface (25) defining an inner flange section and an outer flange section, that is to say mixed.

When making the previous process of stamping or punching to mark the folds (22) and cutting the material, a surface is obtained by clearly marking two areas by means of the folds (22), firstly, the reinforcing frame (20) and the tabs (21). The folds (22) coincide with the inside of the upper contour of the container (10), without necessarily going from end to end, with a sufficient tolerance to allow the absorption of small variations that exist in the manufacturing processes of the container, the gluing area (21) can be of different lengths depending on the space of the gluing area or the force required in the gluing and the height of the same, preferably, at a maximum of the height of the wall (12) and at a minimum the space required to place the adhesive.

In this case, it is not relevant that the height of the upper gluing flange is equal to the height of the container walls (10), since what aligns to the sealing surface (25) of the reinforcing frame (20) of parallel to the bottom of the container (10) and perpendicular to the upper contour of the container (10), is the direct contact of the perimeter holding area with the upper contour of the container (10).

The upper gluing tabs (21) are bent in a downward direction in such a way that they are arranged inside the container (10), in a parallel arrangement and practically together to the side walls of the container to be adhered, preferably with conventional adhesives.

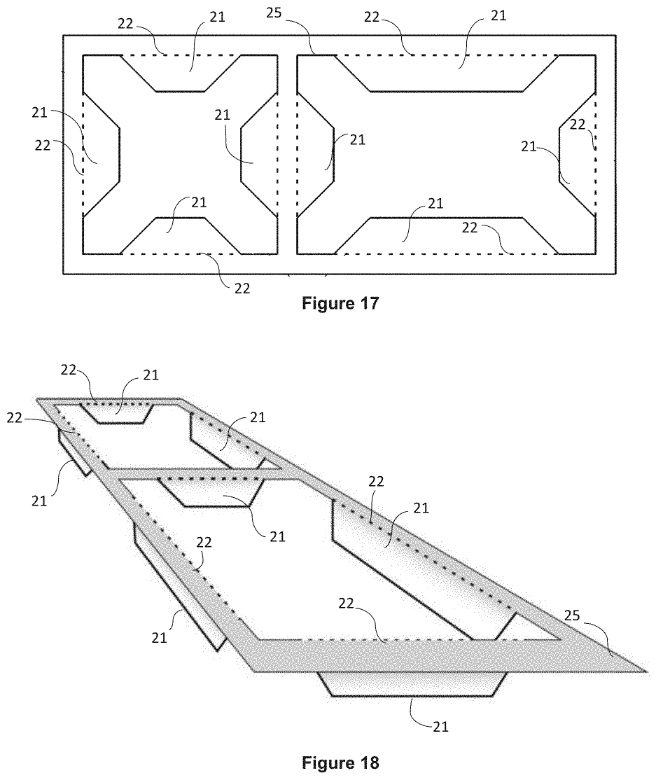

In a fourth embodiment of the reinforcing frame (20), it is arranged in the form of a multi-cavity, with respect to the main container (10), where the reinforcing frame (20) has the adhesion and placement characteristics of the second and third embodiments. aforementioned, from As mentioned previously and as can be seen in FIGS. 17 and 18 where the perimeter of the reinforcing frame (20) is in one piece, but inside it can have a number n of dividing strips (23), that inside they allow to house a plurality of main container (10) where the dimension of the perimeter of each container (10) coincides with the location of the folds (22) of the upper gluing tabs (21) assigned to that division strip (23).

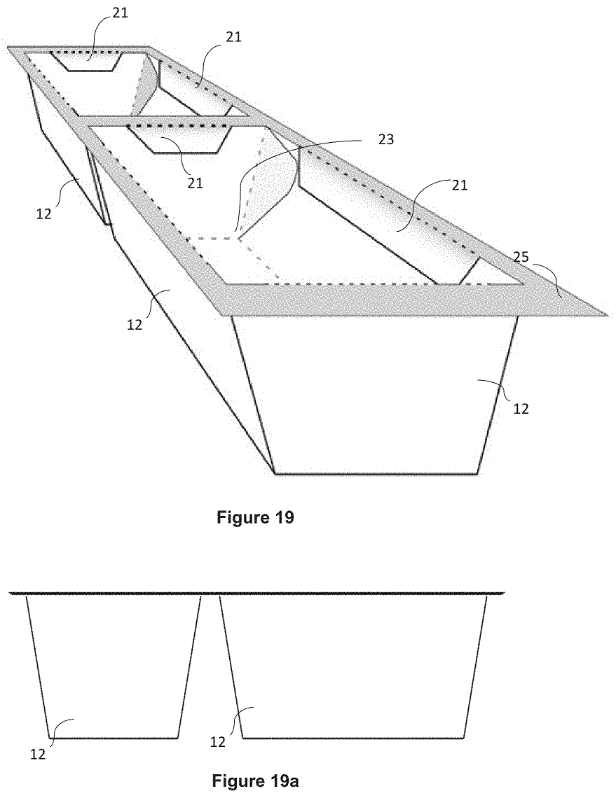

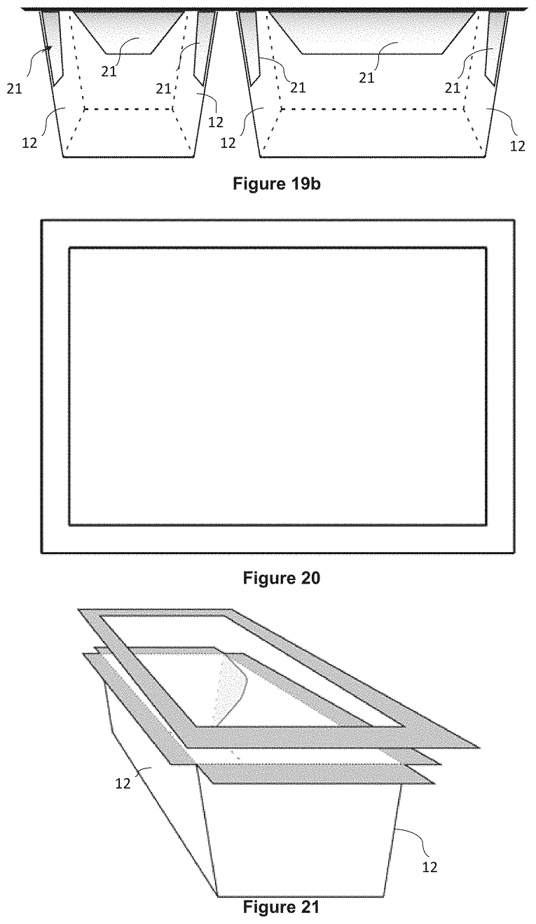

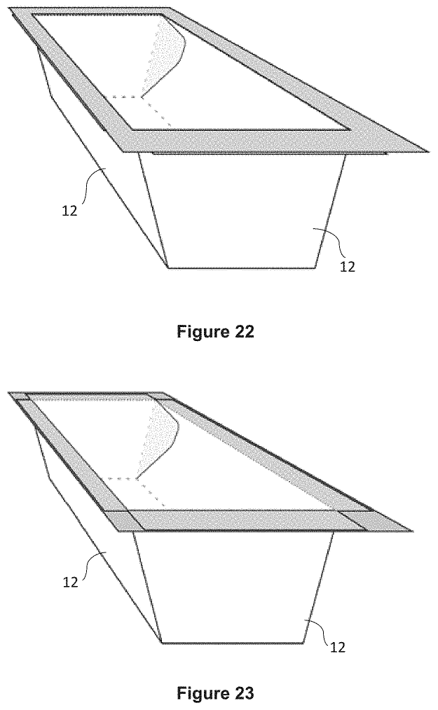

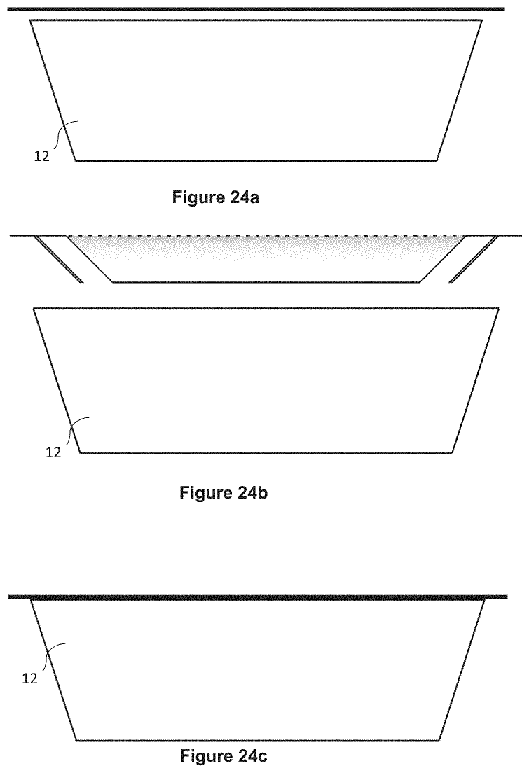

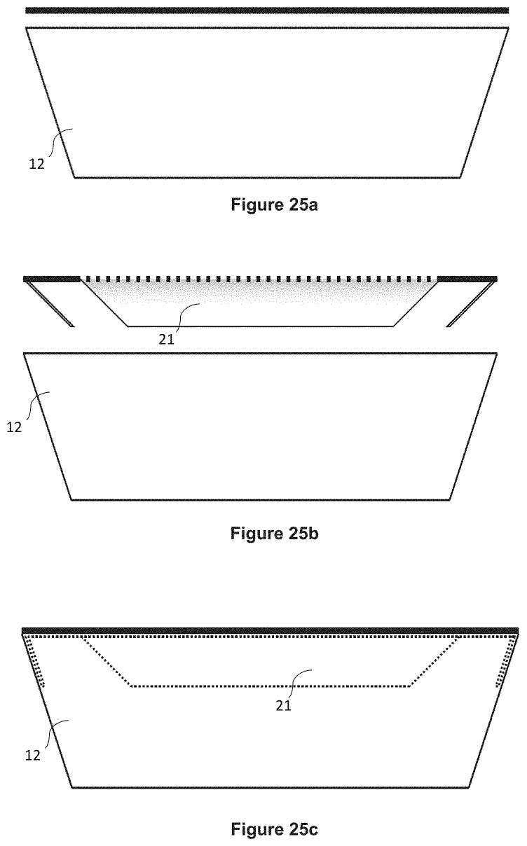

In this fourth embodiment of the reinforcing frame (20), it is arranged outside the upper periphery of the main container (10), as can be seen in FIGS. 19, 19a and 19b, this main container (10) and the reinforcing frame (20) preferably consists of a portion of cardboard or paper, with normally regular geometric shapes. In this fourth embodiment, the sealing surface (25) of the reinforcing frame (20) defines an outer perimeter edge and an inner perimeter edge from which gluing tabs (21) project, so that the inner perimeter edge of the sealing surface (25) has a geometric shape that is dimensionally coincident with the upper perimeter edge of the main container (10), such that the gluing tabs (21) overlap and join with the inside of the walls (12) of the main container (10), and the inner perimeter edge of the sealing surface (25) maintains a dimensional equivalence. relative to the size of the mouth of the container (10), the sealing surface (25) defining an outer flange of the container (10), but additionally in this embodiment the same reinforcing frame (20) is used to join a plurality of main containers (10) keeping them together at the same time, for which it incorporates at least one dividing strip (23), coplanar with the sealing surface (25), which projects between two opposite sides of the sealing surface (25), defining a plurality of cavities where each of the main containers (10) are coupled, where each dividing strip (23) defines two lateral edges, from which gluing tabs (21) project from each lateral edge which overlap and join with the inside of the walls (12) of two adjacent main containers (10), the width of the sealing surface (25) and of the dividing strips (23) depends on what is required protruding from the perimeter edge to the top of the main container (10), preferably this is five orders less with respect to the height of the walls (12) of the container, in this way there is the formation of the sealing surface (25), the upper contour of the container (10), can be straight, parallel to the beginning of the upper gluing tabs (21) or with different shapes, be they curves, cuts, among others.

In a fifth embodiment of the reinforcing frame (20), it is arranged in a reinforcing manner, having as a characteristic that this frame, unlike the previous embodiments, is represented by a single plane and does not have gluing tabs, nor bending plates, it is designed to reinforce prefabricated flanged container frames as shown in FIG. 33 with a surplus of material that remains on top of the walls and is bent to form a perimeter frame but does not have the necessary strength for packing and transportation in addition to the continuity and flat surface required for a tight seal.

It is important to mention that the stiffness of the reinforcing frame (20) is greater than the frames that are generated by leaving surpluses in the upper part of the tray walls since it is a plane that is placed perpendicular to the upper contour of the tray, and it is not a forced fold of the wall which tends to return and does not represent any resistance. Another reason why the stiffness of the reinforcing frame used (20) is much higher is because being a continuous contour, the ends of each of the sides give strength to the next section to remain perpendicular to the upper contour of the main container (10) and even though it is designed so that the reinforcing frame force (20) supports the weight of the main container (10) even with the contents to be transferred, if any of its sides by default give way or bend, the longer it is double more resistance gives the continuation of the frame that is perpendicular as shown in FIG. 32.

This reinforcing frame (20) is adhered to the frame of a prefabricated container with tabs as seen in FIG. 33, either from the top or from the bottom.

In the event that this reinforcement frame is glued from the top, it is not necessary to symmetrically coincide with the perimeter frame of the precast container with flange, as long as c surfaces coincide. Sufficient contact for the gluing of both frames and that they have sufficient resistance.

In the event that the reinforcing frame (20) is adhered by the lower part of the perimeter frame of the prefabricated container with flange, it will necessarily have to have an inner perimeter with measurements equal to the outer perimeter of the upper part of the prefabricated container with their respective tolerances and the outer perimeter of the reinforcing frame (20), although it does not have limitations in the measure, preferably it should coincide with the outer perimeter of the perimeter frame of the container with prefabricated tabs as shown in FIG. 34 for reasons of statics and resistance.

In an additional embodiment, the tabs are adhered to the external walls of the main container (10), having these have a connection through an adhesion medium and whose height, in the same way as in the first gluing embodiment where they are arranged inside, this can be arranged with a height equal to the height of the corresponding wall of the container.

In a further embodiment of the invention, it contemplates the incorporation of a polymeric coating (not illustrated) inside the main container (10), including the sealing surface (25) where this coating consists of preferentially using a film, polymer film or any other synthetic material, preferably by means of a thermoforming and thermo-sealing process by means of pressure, temperature and being able to support said process by means of suction or air pressure.

In one embodiment of the invention, the additives required for placement on the surface of either the main container (10) or the sealing surface film (25) to be heat sealants can be partially or fully applied and This will depend on whether they are sealed on the entire surface or only on the partiality that the additive was intentionally applied.

The application of the polymeric coating inside the main container (10), allows them to contain liquids inside without having direct contact with the surface of the paper or cardboard used in its manufacture, or penetrating the joints of the container, thus avoiding spills, and also favoring the sealing of lids which, in addition to preventing spills, also allows high vacuum and modified atmosphere closures.

In one embodiment considered in the present application, the reinforced containment device can, without being limited to any particular method, be manufactured by a manual or automatic assembly method.

The manual method preferably consists of obtaining a reinforced containment device by assembling the two prefabricated parts that make up said device, the main container (10) and the reinforcing frame (20).

The support frame, previously smoothed, is placed on a flat surface and with the front side down in order to apply the adhesive on the back side of the paper. Once the frame has the adhesive, it will slide into the same pressure position on a mold that has the same shape as the main container (10) until the front face is smooth and supported on the flat surface that receives it, when doing this movement, the gluing tabs are bent to align with the wall of the mold. The second step consists of sliding the main container (10) in the same direction as was done with the reinforcing frame (20) in such a way that the container covers the mold around its perimeter, which is the same way except in the part from the mouth where the frame goes, when doing this, the gluing tabs are already in contact with the adhesive and the interior walls of the container, thus making them a single piece.

Automatic assembly can contemplate the installation of a production plant that can include:

An extended reinforcing frame (20) storage tower.

A main container (10) storage tower, either extended or formed.

A suction system for both towers.

A reinforcing frame (20) transport mechanism or belt.

An adhesive application system either by contact or by injectors.

A reinforcing frame (20) fastening means to prevent deformation.

A main container (10) fastening means inverted on the reinforcing frame (20) already with adhesive.

A means for introducing the mold into tabs for gluing and inside the main container (10).

By means of suction or friction, a reinforcing frame (20) is taken from the frame storage tower and placed on a band or system of chains that make it pass through the area where the adhesive is placed, either with contact rollers or injectors supported by presence sensors. Subsequently the reinforcing frame (20) must remain on the cavity where the mold passes inside to bend the gluing tabs, the reinforcing frame (20) is pressed by a contour that gives support and does not allow it to be abused by the force exerted by the mold when get in.

The main container (10) is placed by similar methods upside down on the reinforcing frame (20) before exerting the pre-bending movement since this same movement is what makes the gluing tabs come into contact with the walls. of the container and preferably the walls (12) of the main container (10) must be contained by some type of support so that force is exerted between the exterior of the main container (10) and the gluing tabs (21), thus improving the gluing efficiency and quality.

Although a preferred exemplary embodiment is shown and specified in detail in the drawings and specification above, these should be viewed as purely exemplary and not as limiting of the invention. In this regard, it is noted that only the preferred exemplary embodiment is shown and specified, and all variations and modifications are to be protected presently or in the future within the scope of protection of the invention as defined in the claims.

1. A reinforced containment device (1) comprising:
a main container (10) having a shape of a tray, the main container is made of paper or cardboard, said main container (10) having a base (11) and four walls (12) erect from a perimeter of the base, having a straight arrangement or with some inclination and are joined together by a series of lateral flanges (13) arranged on the sides of the least two of the walls (12), said walls forming at the top a continuous rectangular perimeter edge;
a reinforcing frame (20) made of a material similar to the material of the main container, where the reinforcement frame is arranged on the continuous perimeter edge of the main container (10) and includes a rectangular sealing surface (25) made up of a perimeter frame made in a single piece and in a single, uniform and continuous plane aligned to the upper contour of the main container (10); and by a plurality of upper gluing tabs (21) extending from the sealing surface (25), said gluing tabs (21) being joined to the sealing surface (25) by folds (22) that give rise to said upper gluing tabs (21), where the gluing tabs (21) overlap and join with the upper part of the walls (12) of the main container (10).

2. A reinforced containment device according to claim 1, wherein the reinforcing frame (20) is arranged inside the main container (10), and the sealing surface (25), of the reinforcing frame (20), defines an outer perimeter edge from where the gluing tabs (21) project and an inner perimeter edge, so that the outer perimeter edge of the sealing surface (25) has a geometric shape that is dimensionally coincident with the upper perimeter edge of the main container (10), so that the gluing tabs (21) overlap and join with the inside of the walls (12) of the main container (10), the sealing surface (25) defining an inner flange of the container (10).

3. The reinforced containment device according to claim 2, wherein the outer perimeter edge of the sealing surface (25) maintains a dimensional equivalence with respect to the size of the main container (10) except for the dimension that is required for the sealing surface (25) is introduced into the main container (10) in a perpendicular manner.

4. The reinforced containment device according to claim 1, wherein the reinforcing frame (20) is arranged outside the upper periphery of the main container (10), and the sealing surface (25), of the reinforcing frame (20), defines an outer perimeter edge and an inner perimeter edge from which the gluing tabs (21) project, so that the inner perimeter edge of the sealing surface (25) presents a geometric shape that is dimensionally coincident with the upper perimeter edge of the main container (10), so that the glue tabs (21) overlap and join with the inside of the walls (12) of the main container (10), defining the sealing surface (25) an outer flange of the container (10).

5. The reinforced containment device according to claim 4, wherein the inner perimeter edge of the sealing surface (25) maintains a dimensional equivalence with respect to the size of the mouth of the container (10), and the width of the sealing surface (25) depends on what is required to protrude from the upper perimeter edge of the main container (10), preferably this is five orders less with respect to the height of the container walls (12), in this way we have the formation from the sealing surface (25).

6. The reinforced containment device according to claim 1, wherein the sealing surface (25), of the reinforcing frame (20), defines an outer perimeter edge and an inner perimeter edge, and four sides, where alternately one of the sides of the sealing surface have glue tabs and other sides are free of glue tabs, where the glue tabs are projected from the outer perimeter or the inner perimeter of the sides with gluing tabs (21), said gluing tabs (21) being attached to the sealing surface by means of folds (22), so that the gluing tabs (21) overlap and join with the inside of the walls (12) of the main container (10), and the sealing surface (25) has straight sides free of pest years of gluing tabs (21), alternated with the sides with gluing tabs (21), where the straight sides, free of tabs of the sealing surface (25), lie on the corresponding upper edges of the corresponding sides of the main container (10), wherein the upper edge of the main container (10) may coincide with the inner perimeter of the straight, flange-free sides of the sealing surface (25) defining an outer flange, or the upper edge of the main container (10) may coincide with the outer perimeter of the straight, flange-free sides of the sealing surface (25) defining an inner flange, or the upper edge of the main container (10) may be disposed between the inner and outer perimeter of the straight sides, free of flanges, of the sealing surface (25) defining an inner flange section and an outer flange section.

7. The reinforced containment device according to claim 1, wherein the reinforcing frame (20) is arranged outside the upper periphery of the main container (10), and the sealing surface (25), of the reinforcing frame (20), defines an outer perimeter edge and an inner perimeter edge from which gluing tabs (21) project, so that the inner perimeter edge of the sealing surface (25) presents a geometric shape that is dimensionally coincident with the upper perimeter edge of the main container (10), so that the gluing tabs (21) overlap and join with the inside of the walls (12) of the main container (10), and additionally the reinforcement frame (20) is used to join a plurality of main containers (10) keeping them together at the same time, for which it incorporates at least one dividing strip (23), coplanar with the sealing surface (25), which projects between two opposite sides of the sealing surface (25), defining a plurality of cavities where each of the main containers (10) are coupled, where each dividing strip (23) defines two lateral edges, whence of each lateral edge gluing tabs (21) are projected which overlap and join with the inside of the walls (12) of two adjacent main containers (10).

8. The reinforced containment device according to claim 7, wherein the width of the sealing surface (25) and the dividing strips (23) depends on what is required to protrude from the upper perimeter edge of the main container (10), preferably this is five orders less with respect to the height of the container walls (12), in this way the sealing surface (25) is formed.

9. The reinforced containment device according to claim 1, wherein the reinforcing frame (20) is arranged in a reinforcing manner in a single plane and wherein the main container 10 has a surplus of material that remains on top of the walls and is bent to form a perimeter frame that does not have the necessary strength for packing and transport, so that the stiffness of the reinforcing frame (20) is greater than the frames that are generated by leaving surpluses on the upper part of the walls of the tray since it is a plane that is placed perpendicular to the upper contour of the container, and the reinforcing frame (20) being a continuous contour, the ends of each of its sides give strength to the excess material to remain perpendicular to the upper contour of the main container (10), this reinforcing frame (20) is adhered to the frame of a prefabricated container.

10. The reinforced containment device according to claim 1, wherein the main container (10) and the reinforcing frame (20) are made of cardboard, thin cardboard, coated cardboard, corrugated cardboard.

11. The reinforced containment device according to claim 1, wherein the reinforcing frame (20) serves to be able to close with different types of lids, preferably heat sealable, with adhesives, pressure etc. and wherein said closure increases the hermeticity inside the container (10).

12. The reinforced containment device according to claim 1, wherein the reinforcing frame (20) of the reinforced containment device (1) is preferably composed of a sheet of paper, cardboard, or similar materials.

13. The reinforced containment device according to claim 1, wherein the gluing tabs (21) can be of different lengths depending on the space available for gluing or the force required in gluing and the height should preferably be, a maximum of the height of the wall (12) of the main container (10) and at least a height of five times less than the height of the container.

14. The reinforced containment device according to claim 1, wherein the upper gluing tabs (21) are bent in a downward orientation in such a way that they are arranged overlapping inside the main container, parallel and practically together with the walls (12), where these are adhered by means of conventional adhesives.

15. The reinforced containment device according to claim 1, wherein the upper gluing tabs (21) have a height equal to the height of the wall (12) of the container (10) which helps the reinforcement frame (20) is placed more easily and with greater precision in a parallel way with respect to the bottom (11) of the main container (10), having that the tabs are arranged perpendicular with respect to the upper contour of the container (10), in addition to that in this Specific case, and as an assembly option, the tabs (21) could not adhere to the wall (12) and only support them on the bottom (11) of the container (10) where the union is made by means of an external wrap that holds the two pieces together.

16. The reinforced containment device according to claim 1, further including a polymeric coating inside the main container (10), including the sealing surface (25) where this coating consists of preferentially using, a film, polymer film or any other synthetic material, preferably by means of a thermoforming and thermo-sealing process by means of pressure, temperature.

17. The reinforced containment device according to claim 1, wherein the upper contour of the container (10) can be straight, parallel to the beginning of the upper gluing tabs (21) or with different shapes, be it curves, cuts, among others.
